(19) United States
(12) Patent Application Publication
(10) Pub. No.: US 2012/0304374 A1
(43) Pub. Date: Dec. 6, 2012

(54) HYBRID INFRARED SAUNA

(75) Inventor: Darcy AMENDT, (US)

(73) Assignee: SPA LOGIC INC., Calgary (CA)

(21) Appl. No.: 13/489,360

(22) Filed: Jun. 5, 2012

Related U.S. Application Data
(60) Provisional application No. 61/493,865, filed on Jun. 6, 2011.

(51) Int. Cl. A61H 33/06

(52) U.S. Cl. 4/524

(57) ABSTRACT

A hybrid sauna provides far infrared radiant heat to a user from a first side of a far infrared heat panel while waste heat is collected as heated air from the backside of the panel by flowing air through an air passageway and across the panel. The heated air is distributed into a user space through openings in a divider structure incorporating the panel, the divider separating the user space from the air passageway. The air circulates in the sauna natural thermal cycle or by forced air. The heat panels and environment may be controlled by a short range wireless remote.

### CROSS-REFERENCE TO RELATED APPLICATIONS

This application claims the benefit of U.S. Provisional Patent application Ser. No. 61/493,865, filed Jun. 6, 2011, the entirety of which is incorporated herein by reference.

### FIELD

The invention relates to infrared saunas, more particularly saunas implementing both infrared and heated air for providing benefits to the user.

### BACKGROUND

Conventionally, there are two choices for saunas, dry saunas and infrared saunas. Dry saunas rely only on convection to supply heated air to the sauna user and conduction to transfer heat from the heated air to the user's body. Infrared saunas typically use the far infrared (FAR) portion of the electromagnetic spectrum (5.6 to 1,000 microns). The FAR segment of the electromagnetic spectrum occurs just below red light. FAR is not visible but is received by the user and can be felt as heat. Saunas using FAR are believed to impart health and aesthetic effects.

Options for producing FAR include far infrared heat panels such as, carbon fibre heaters and ceramic heaters. Carbon fiber heaters are generally accepted as having advantages including a large infrared emitting surface and being sufficiently cool to avoid serious injury if accidentally touched. Basically, carbon fiber heaters are thin, large surface area composite assemblies of electrically stimulated, carbon-impregnated material sandwiched between glass sheets. The composite assembly is vulnerable to overheating.

One aspect of FAR is that a user does not need to be immediately adjacent the heater as long as the infrared radiant energy reaches the user. The user is directly warmed, without needlessly heating the air or area around the user. Such saunas need not be enclosed and, if so, are typically not insulated due to the low enclosure temperatures.

Applicant understands that, to date, conventional saunas have implemented carbon fiber heaters for FAR emissions only. The saunas are generally not insulated and any heat generated at the heater has been shed by conduction through the sauna walls.

FAR heaters use meagre power and typically operate on household current. Some of the health benefits of FAR heaters are believed to be related to mere exposure to the emitted wavelength, including deep tissue therapy, resulting in only some warming of the user. Thus the user's perception of receiving some health benefit is less than immediately apparent and, more so, one left to faith. Thus, some users tend to abandon the FAR sauna experience and course of treatment before having received the full potential of benefits available.

What is required is a sauna having a more overt and effective environment for encouraging greater user participation, maximum efficiency, and perceived benefits.

### SUMMARY

A hybrid sauna is provided which both heats the environment about the user and generates far infrared (FAR) energy for direct heating and health benefits of the user. The hybrid sauna combines the benefits of FAR saunas and traditional organic dry saunas. Carbon fibre FAR heat panels provide radiant energy. Such panels are vulnerable to component overheating. Accordingly, the hybrid sauna described herein implements FAR heat panels within a system and control which provides radiant energy, cools the panels and provides dry heat to the sauna enclosure for perceptible effect and enjoyment by a user.

Generally, the FAR heat panels are arranged in an enclosure with an emission surface directing radiant energy to the user, while also incorporating the opposing backside of the panel in a heat exchanger to an air passageway. The air passageway collects waste heat and directs it into the user space. The air can circulate through the passageways and user space by natural convention or by forced air. Controls ensure at least user space environmental temperature control and can also provide panel control and overheating protection. Further a wireless control system is provided for interfacing with various controls and modules of the sauna including an interface to an entertainment system.

Therefore, in one aspect a hybrid sauna comprises an enclosure forming a user space and at least one FAR heat panel having a first panel side for emitting FAR and a second panel side for releasing waste heat, the first side oriented for emitting the FAR towards the user space. At least one air passageway is provided in fluid communication with the second panel side for removing waste heat from the second panel side and producing a heated air. The heated air is directed through an air outlet to the user space.

The at least one panel and air passageway can be multiple panels and passageways, typically one passageway per panel. The heat air can be discharged adjacent a bottom the user space for natural circulation therethrough. The air can be drawn from the ambient environment outside the enclosure using an air mover.

### BRIEF DESCRIPTION OF THE DRAWINGS

FIG. 1 is a perspective cutaway view of a sauna having an enclosure and fit with one embodiment of a hybrid far infrared and dry sauna;

FIG. 2 is a perspective partially assembled view of an embodiment of a heat exchange unit suitable for far infrared heat panels of a hybrid sauna of FIG. 1, the heat exchanger with air moving therethrough for delivery of conditioned air; and

FIG. 3 is a partial, side, cross-sectional view of the enclosure of FIG. 1 illustrating perspective view of an enclosure illustrating both far infrared emissions and heated, conditioned air for warming the enclosure.

### DETAILED DESCRIPTION

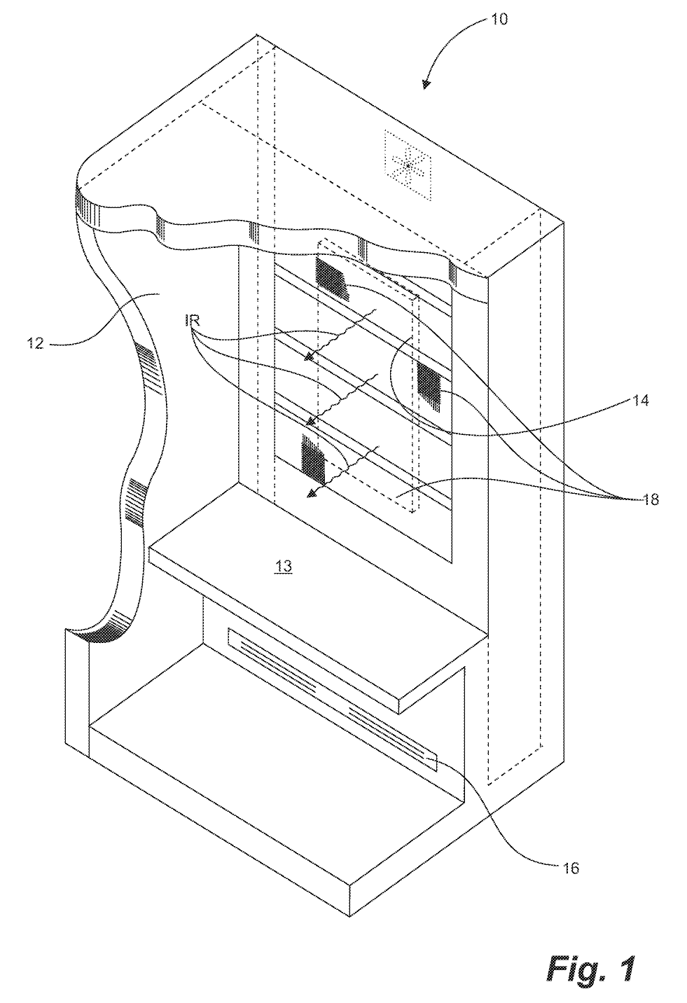

As shown in FIG. 1, a hybrid sauna 10 is illustrated having an enclosure 12 defining a user space 13 for a user to enjoy the sauna. The sauna has at least one far infrared (FAR) radiant heat panel 14 (in dotted lines) for the use of the user and an air outlet 16 for discharging heated air H. The enclosure 12 includes enclosing walls, a user access opening and can include windows and a variety of conventional sauna comfort features not shown

At least one FAR heat panel 14 is installed at one or more locations in the enclosure 12 with an open line of infrared transmission to the user space 13. As shown, FAR heat panel or panels 14 are installed towards a back of the enclosure 12 for emitting radiant energy IR forwards, towards the user in the user space 13. For aesthetics and separating the user space from the panel 14, a FAR-transparent fabric or material 18 is situated between the FAR heat panels 14 and the user space 13, camouflaging the FAR heater 14 yet emitting the radiant IR energy therethrough.

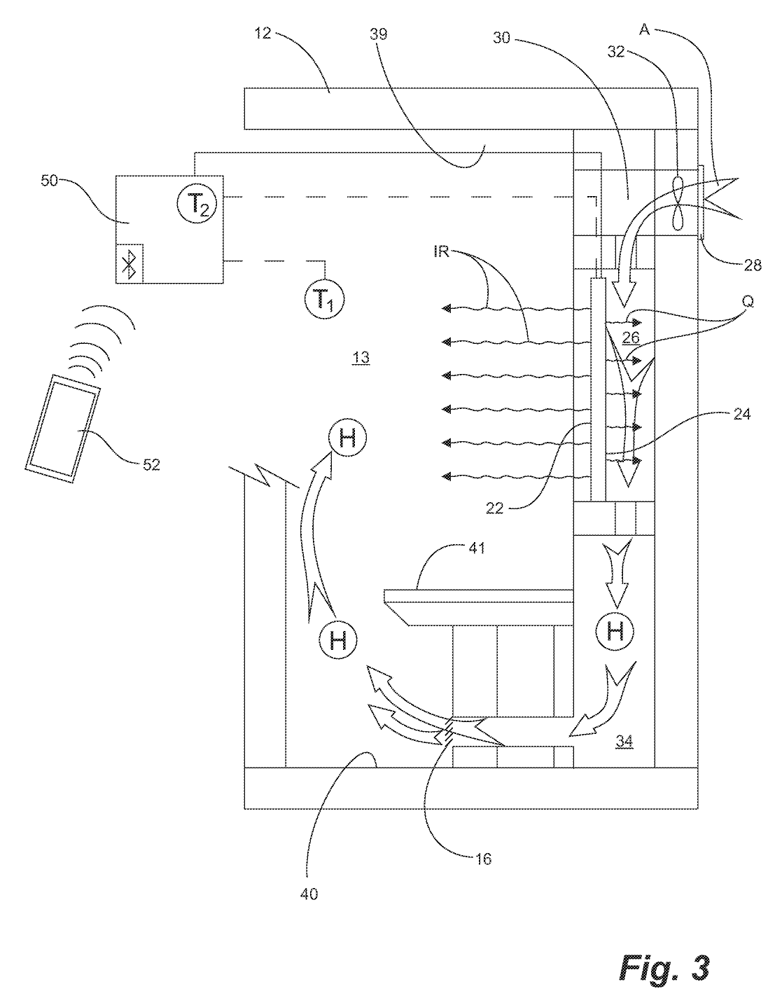

Further, means are provided for recovering waste heat Q from the FAR heat panels 14 (See FIG. 3) which is otherwise lost to the environment outside of the enclosure. Recovered heat Q is discharged from the air outlet 16 for substantially immediate and perceptible enjoyment by the user.

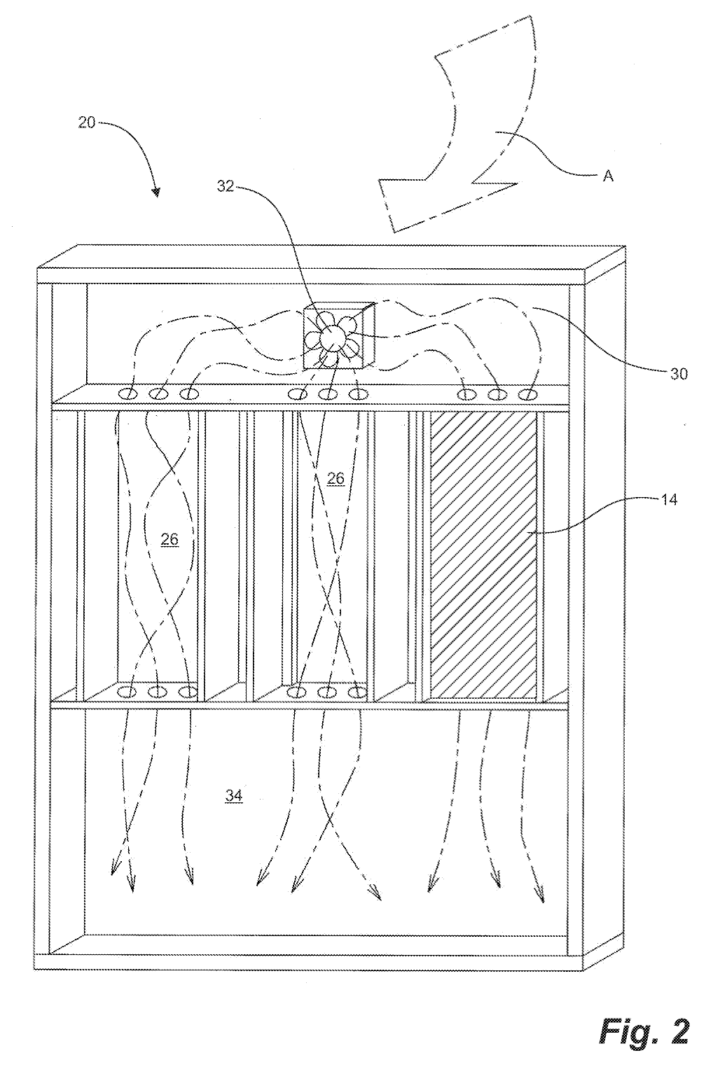

With reference to FIGS. 2 and 3, each FAR heat panel 14 forms part of a panel-to-air heat exchanger 20. Each FAR heat panel 14 is a flat, planer panel, thin in depth and having a front-side first panel side 22, comprising a low temperature radiant emitter oriented towards the user space, and an opposing, backside second panel side 24 for dumping waste heat Q. Each FAR heat panel 14 is associated with its own air passageway such as a heat transfer duct 26. The second side of the FAR panel 14 faces the duct 26 and is in thermal communication therewith. Air A flows through the duct 26 passes over the second side of FAR heat panel 14, receiving waste heat Q therefrom, resulting in heated air H for ultimate discharge to the user space 13. The air circulation cools the FAR heat panels 14. The FAR heat panel 14 is fit to a divider structure between the user space and the at least one air passageway, wherein the at least one FAR infrared heater is fit to the divider.

Air A can circulate across the backside of the panel 14 by natural thermal cycle, such as convection or be forced thereby. While air A can pass across the FAR heat panel 14 in any direction to recover heat Q, in one embodiment, heated air H, passes from top to bottom across the panel 14 and is discharged adjacent a bottom 40 of the user space 13. Discharged heated air H can circulate by a natural thermal cycle, such as convection, up through the user space 13. The air outlet 16 can be in fluid communication with, and adjacent, an upper end 39 of the user space 13 or enclosure 12. Air A can be forcibly circulated through the user space 13 and duct 26 using various air movers. Further, one might initially internally recirculate heated air H, particularly during a sauna preheat stage.

In an embodiment, during steady state operation, fresh outside air A is sourced from the environment outside the enclosure. Outside air A flows through an inlet 28 and into the duct 26 for discharge through air outlet 16. The inlet 28 can be located adjacent the upper end 39 of the enclosure 12 and be urged into the duct 26 using an air mover such as a fan 32 for discharge through the air outlet 16 and through the divider adjacent the bottom 40 of the enclosure 12.

In an embodiment, the at least one FAR heat panel 14 is two or more panels 14,14 . . . three being shown, and at least one passageway or duct 26.

To maximize heat collection, each panel 14 is provided with its own duct 26. Outside air A flows into an intake header 30 in fluid communication with and for distribution into the multiple ducts 26,26, . . . . Similarly, a discharge header 34 is in fluid communication with and for collection of heated air H from the multiple ducts 26,26, . . . .

With reference to FIG. 3, the outside air A to the enclosure 12 enters the intake header 30 adjacent the upper end 39 and travels along the heat transfer ducts 26 receiving waste heat Q rejected from the FAR heat panels 14. The heated air H is collected in the discharge header 34 for discharge adjacent the bottom 40 of the enclosure 12. Heated air H naturally rises from the bottom 40, through the user space 13, resulting in a comfortable environment for a user. A seat 41 is provided for user comfort and is placed adjacent the FAR heat panels 14.

The enclosure 12 materials of construction are generally of non-toxic glue and cedar chosen for its pleasant and non-toxic characteristics in sauna conditions. All materials meet RoHS (Restriction of the use of certain Hazardous Substances) standards, including being free of lead and Cadmium 6. Other than windows and other features not so amenable, the enclosure 12 is insulated to retain heat from the heated air H.

In one embodiment, the FAR heat panels 14 are carbon fibre FAR heat panels 14 supplied with household 110V/15A current and can provide infrared in the 7 to 14 micron range, with emphasis on the 8.4 to 9.4 micron range used for infrared therapy. Each of three carbon fibre FAR heat panels 14 can be about 250 Watts each, which can raise the comfortably temperature of a standard sized enclosure 12 in about five minutes, consuming a maximum of about 1.27 kW/h which at current rates of $0.11 per kW is about $0.14/h.

As stated, carbon fibre FAR heat panels 14 are vulnerable to overheating. As described herein, waste heat Q is recovered as heated air H, circulated for the comfort of the user. Further one or more temperatures can be monitored to manage user comfort and protect the FAR heat panel 14. A controller 50 is electrically connected to one or more of the FAR heat panels 14 and to enclosure comfort controls. One or more temperature sensors T2 monitor the operating panel temperature of the FAR heat panels 14. Depending upon the operating state of the heat exchanger 20, the controller 50 will protect the panels 14 by either discontinuing energy input thereto or removing more heat. The controller 50 can shut off the FAR heat panels 14 or initiate the flow of air A through the at least one air passageway and over the second panel side if the air temperature exceeds a if the temperature exceeds a set point or threshold temperature.

Another temperature sensor T1 can monitor the temperature of the user space 13 and modulate FAR heat panels 14 and fans 32 to maintain the temperature T1 of the user space. A manual input pad enables user adjustment of the user space environment.

The controller 50 is also equipped for receiving control signals from a wireless remote 52, including typically, a smartphone, tablets and similar devices and a wireless and wired interface at the sauna. The wireless interface receives a combination of communication signals transmitted from the wireless remote device. A smartphone application program can be paired with the controller 50 through a wireless interface for controlling all of the regular functions of the hybrid sauna 10.

In one embodiment, the wireless system includes a form of short-wavelength radio transmission, such as that under the BLUETOOTH® protocol. The Bluetooth® word mark and logos are registered trademarks owned by Bluetooth SIG, Inc. of WA, USA. A BLUETOOTH™ microcontroller receives and decodes the BLUETOOTH™ signals, and a Wi-Fi router receives and decodes the communication signals, the communication signals being transmitted using Wi-Fi protocols.

The application program can activate many of the sauna functions remotely including: preheating the hybrid sauna 10 and providing a return signal when the temperature is at a setpoint; setting timers for length of treatment, setting hybrid sauna performance including temperature, use of FAR, or both FAR and hybrid heat. BLUETOOTH®-enabled, and media-loaded devices can also stream media to the controller for presentation on audio, visual components in the sauna. This avoids the handling of conventional media in a hybrid sauna environment. Further, this frees the user from conventional automobile-stereo constraints typically supplied with other saunas.

Wireless connectivity to the wireless remote device and networks offers a broad range of connectivity and operability, including internet access and remote diagnostics. The wireless interface such as the Wi-Fi router can receive and decode communication signals being transmitted using Wi-Fi protocols.

The Embodiments of the Invention in which an Exclusive Property or Privilage is being Claimed are Defined as Follows:

1. A hybrid sauna comprising:
an enclosure forming a user space;
at least one far infrared heat panel having a first panel side for emitting far infrared and a second panel side for releasing waste heat, the first side oriented for emitting the far infrared towards the user space;
at least one air passageway in fluid communication with the second panel side for removing waste heat from the second panel side and producing a heated air; and
an air outlet for directing the heated air to the user space.

2. The hybrid sauna of claim 1 wherein the air outlet is in fluid communication with at a top of the user space.

3. The hybrid sauna of claim 1 further comprising an air mover in the at least one passageway for forcing air over the second panel side, and wherein the air outlet is in fluid communication with a bottom of the user space.

4. The hybrid sauna of claim 1 further comprising one air passageway, of the at least one air passageways, for each of the at least one far infrared heat panel.

5. The hybrid sauna of claim 1 further comprising:
at least one sensor for monitoring a panel temperature of the at least one far infrared heat panel; and
a controller for shutting off the at least one far infrared heater if the panel temperature exceeds a threshold temperature.

6. The hybrid sauna of claim 1 further comprising:
at least one sensor for monitoring an air temperature of the heated air flowing in the at least one air passageway; and
a controller for flowing air through the at least one air passageway and over the second panel side if the air temperature exceeds a threshold temperature.

7. The hybrid sauna of claim 1 further comprising:
at least one sensor for monitoring a user space temperature of the user space; and
a controller for managing one of or both of the at least one far infrared heater and a flow of air through the at least one air passageway if the user space temperature exceeds a user space threshold temperature.

8. The hybrid sauna of claim 7 wherein the controller is operatively connected to the at least one far infrared heater and to an air mover in the at least one air passageway, the air mover forcing air over the second panel side.

9. The hybrid sauna of claim 7 wherein
the controller further comprises a wireless interface; and
a wireless remote for communication with the controller's wireless interface.

10. The hybrid sauna of claim 1 wherein the enclosure further comprises a divider structure between the user space and the at least one air passageway, wherein the at least one far infrared heater is fit to the divider.

11. The hybrid sauna of claim 10 wherein the divider structure comprises the air outlet at a bottom end of the divider structure for fluid communication between the at least one air passageway and a bottom of the user space.

12. The hybrid sauna of claim 11 wherein the at least one air passageway has an air inlet adjacent a top of the enclosure.

13. The hybrid sauna of claim 11 wherein the at least one air passageway further comprises:
an air inlet at an upper end thereof; and
an air mover in the at least one air passageway to force air flow from the air inlet, over the second panel side to collect waste heat, and out of the air outlet.

14. The hybrid sauna of claim 13 wherein the air inlet is connected to a source of air external to the enclosure.

15. The hybrid sauna of claim 1 wherein the user space further comprises a seat for locating a user adjacent the first panel side.

16. The hybrid sauna of claim 1 wherein the user space further comprises a seat for locating a user adjacent the first panel side and the heated air discharges below the user.

17. The hybrid sauna of claim 1 wherein the at least one far infrared heat panel is two or more far infrared heat panels, the at least one air passageways further comprising:
two or more passageways, one passage for each far infrared heat panel;
an intake header for distributing air to each of the two or more passageways; and
a discharge header for collecting heated air from the two or more passageways.
